(19) United States
(12) Patent Application Publication
(10) Pub. No.: US 2019/0004080 A1
(43) Pub. Date: Jan. 3, 2019

(54) High-throughput Screening System Based on Single Manipulator

(71) Applicant: Jiangnan University, Wuxi (CN)

(72) Inventors: Jingwen Zhou, Wuxi (CN); Jian Chen, Wuxi (CN); Meng Ning, Wuxi (CN); Xiaomei Cao, Wuxi (CN); Guocheng Du, Wuxi (CN); Weizhu Zeng, Wuxi (CN); Qiuju Zhang, Wuxi (CN); Jun Fang, Wuxi (CN)

(21) Appl. No.: 15/708,895

(22) Filed: Sep. 19, 2017

(30) Foreign Application Priority Data
Jun. 30, 2017 (CN) 201710523893.1

(51) Int. Cl. G01N 35/10; G01N 35/02; G01N 35/04

(52) U.S. Cl. CPC G01N 35/1083; G01N 35/026; G01N 2035/0465; G01N 35/1074; G01N 2035/1086; G01N 35/04

(57) ABSTRACT

The invention provides a high-throughput screening system based on a single manipulator, and belongs to the field of biotechnology and detection equipment. A high-throughput screening system based on single manipulator, comprises of one manipulator which is surrounded by deep well plate loading platform, shallow well plate loading platform, pipetting head loading platform, control cabinet, waste pipetting heads container platform, shallow well plate recycling platform, deep well plate recycling platform, Microplate Reader with oscillating mixer and items-placing platform in a counterclockwise or clockwise order. The present invention is a combination of microbiology and mechanics. It promotes the automation of microbial high-throughput screening system for screening microorganisms with specific properties. It effectively contributes to the development of microbial breeding technology and further promotes the development of microbial science.

### CROSS-REFERENCES AND RELATED APPLICATIONS

This application claims the benefit of priority to Chinese Application No. 201710523893.1, entitled “A high-throughput screening system based on single manipulator”, filed Jun. 30, 2017, which is herein incorporated by reference in its entirety.

### BACKGROUND OF THE INVENTION

### Field of the Invention

The invention relates to a high-throughput screening system based on single manipulator, and belongs to the field of biotechnology and detection equipment.

### Description of the Related Art

The high-throughput screening technology refers to a new technique based on the molecular level and cell level experimental methods, using automatic systems, micro-plate carriers, sensitive detectors, and data processing and control software. High Throughput Screening allows a researcher to conduct millions of biochemical, genetic or pharmacological tests at the same time and to rapidly select out what he wants. In the context of the continuous development of microbial breeding technology, screening techniques determine the efficiency of hitting the target strains from a large pool of bacteria.

At present, domestic high-throughput screening system is mainly dependent on imported equipment. Sample transfer between the test devices still requires manual operation. There is still a need for manual search and matching between the final screening selection and the sample. There are usually tens of millions of samples need to be detected. The single operation step makes work tedious and the operators are prone to fatigue and error, which restricts the development of high-throughput screening to some extent. At present, most of China's microbial screening relies on imported equipment. Robots have not yet been used to implement automated high-throughput screening systems.

### SUMMARY OF THE INVENTION

The invention is aimed at solving the main problems that the sample screening process of domestic high-throughput screening system is non-automatic and the number of the sample screening targets is enormously limited. It is necessary to provide a high-throughput screening system with single manipulator based on the combination of microbial breeding and robot technology.

The high-throughput screening system based on single manipulator comprises of one manipulator which is surrounded by deep well plate loading platform, shallow well plate loading platform, pipetting head loading platform, control cabinet, waste pipetting heads container platform, shallow well plate recycling platform, deep well plate recycling platform, Microplate Reader with oscillating mixer and items-placing platform in a counterclockwise order.

In one embodiment of the present invention, the high-throughput screening system based on single manipulator comprises of one automated loading and unloading manipulator, one 96-deep well plate loading platform, one 96-shallow well plate loading platform, one 96-pipetting head loading platform, one control cabinet, one 96-waste pipetting heads container platform, one 96-shallow well plate recycling platform, one 96-deep well plate recycling platform, one Microplate Reader with oscillating mixer and one items-placing platform. The items-placing platform has two 3-DOF slipways for drawing the supernatant from the 96-deep well plate and adding staining agent separately. Every 3-DOF slipways has installed 96-channal pipetting system.

In one embodiment of the present invention, the automated loading and unloading manipulator is used to (1) carry the 96-shallow well plate, 96-deep well plate and pipetting heads container to the appropriate position on items-placing platform; (2) after adding staining agent, carry the 96-shallow well plate to the Microplate Reader for detection; (3) after detection, then carry the well plate and used pipetting head container to corresponding recycling platform.

In one embodiment of the present invention, the 96-deep well plate loading platform, 96-shallow well plate loading platform and 96-pipetting head loading platform have grooves for placing the 96-well plate.

In one embodiment of the present invention, the 96-pipetting head loading platform has a groove for placing a pipette head container.

In one embodiment of the present invention, the items-placing platform has grooves for placing 96-well plate and pipette head container.

In one embodiment of the present invention, the automated loading and unloading manipulator is equipped with a pressure sensor on the endmost clamping device and a visual sensor for automatically capturing the well plate on loading and items-placing platform. The first connecting rod of the clamping device is driven directly by motor and the ends are connected with the second connecting rod and the third through the pin respectively and are rotatable along the junction; the second connecting rod is connected with the fourth through the pin and is rotatable along the junction; the third connecting rod is connected with the fifth through the pin and is rotatable along the junction, the fourth connecting rod and the fifth are respectively fixedly connected with the first fixture block and the second one.

In one embodiment of the present invention, the high-throughput screening system based on single manipulator is equipped with sensors for detecting the presence and departure of the well plate or head container at each working position.

In one embodiment of the present invention, the slipway is equipped with a collision sensor.

The present invention is a combination of microbiology and mechanics. It promotes the automation of microbial high-throughput screening system for screening microorganisms with specific properties. The high-throughput screening system based on single manipulator can handle samples like microbial fermentation supernatant and microbial cell disruption. Manual operation takes five minutes to detect one 96-well plate, while this system can handle 20 96-well plates per minute which shows a great improvement in efficiency. The system can effectively contribute to the development of microbial breeding technology and further promote the development of microbial science.

### BRIEF DESCRIPTION OF DRAWINGS

FIG. 1 is a general frame diagram of one embodiment of the present invention;

FIG. 2 is a frame diagram of the slipway;

FIG. 3 is a frame diagram of the clamping device in the end of the manipulator;

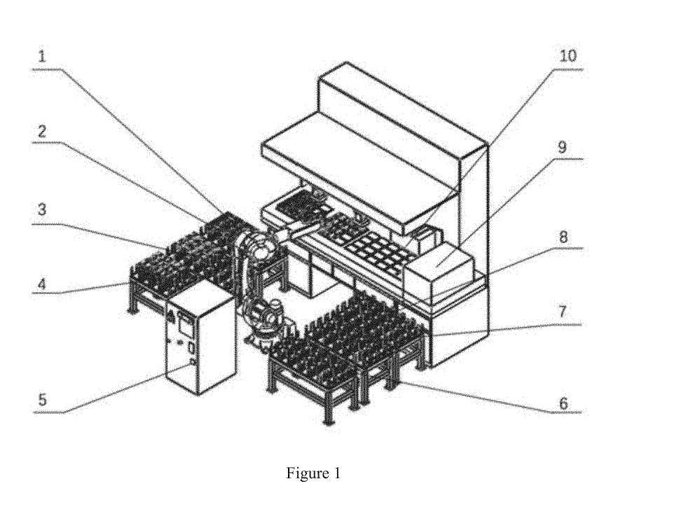

In the diagrams: 1: manipulator, 2: 96-deep well plate loading platform, 3: 96-shallow well plate loading platform, 4: 96-pipetting head loading platform, 5: control cabinet, 6: 96-waste pipetting heads container platform, 7: 96-shallow well plate recycling platform, 8: 96-deep well plate recycling platform, 9: microplate reader, 10: placing platform, 11: the first slipway, 12: the second slipway, 13: the first connecting rod, 14: the second connecting rod, 15: the third connecting rod, 16: the fourth connecting rod, 17: the fifth connecting rod, 18: the first fixture block, 19: the second fixture block, 20: the pipette.

### DETAILED DESCRIPTIONS OF EMBODIMENTS

A further description of the present invention is provided in conjunction with the diagrams and embodiments:

The high-throughput screening system based on single manipulator comprises of one manipulator which is surrounded by 96-deep well plate loading platform 2, 96-shallow well plate loading platform 3, 96-pipetting head loading platform 4, control cabinet 5, 96-waste pipetting heads container platform 6, 96-shallow well plate recycling platform 7, 96-deep well plate recycling platform 8, oscillating mixer and microplate reader 9, placing platform 10, the first slipway 11, the second slipway 12, the pipette 20. The loading platform and placing platform 10 wherein said are both provided with grooves for placing 96-well plate and head container. The placing platform 10 is equipped with microplate reader which possesses oscillating mixer. The pipette 20 on slipway 11 is used for drawing the supernatant from the 96-deep well plate to 96-shallow well plate and the other on slipway 12 is used for adding the staining agent. One automated loading and unloading manipulator is used to (1) carry the 96-shallow well plate, 96-deep well plate and pipetting heads container to the appropriate position on items-placing platform and (2) carry the staining agent added 96-shallow well plate to the microplate reader for mixing and detecting; (3) then carry the well plate and used pipetting head container to corresponding recycling platform.

For example, in order to select out microorganisms which can secret specific substances from 100 strains. One can cultivate 100 strains to obtain their fermentation broth. Fermentation broth is added to the deep-well plate with parallel samples. These samples are transferred by the manipulator from deep-well plate to the shallow one for detection by microplate reader. Rapidly, according to the test results of microplate reader, the target strains are selected from 100 microorganisms. And then the samples are sent to the waste station. During manual operation, sampling and transferring plates take too much time. When using high-throughput screening system based on single manipulator, operator can spent time analyzing data or something else while the screening system is running. And of course, the samples added to the deep-well plate can be microbial fermentation supernatant or microbial cell disruption which contains markers.

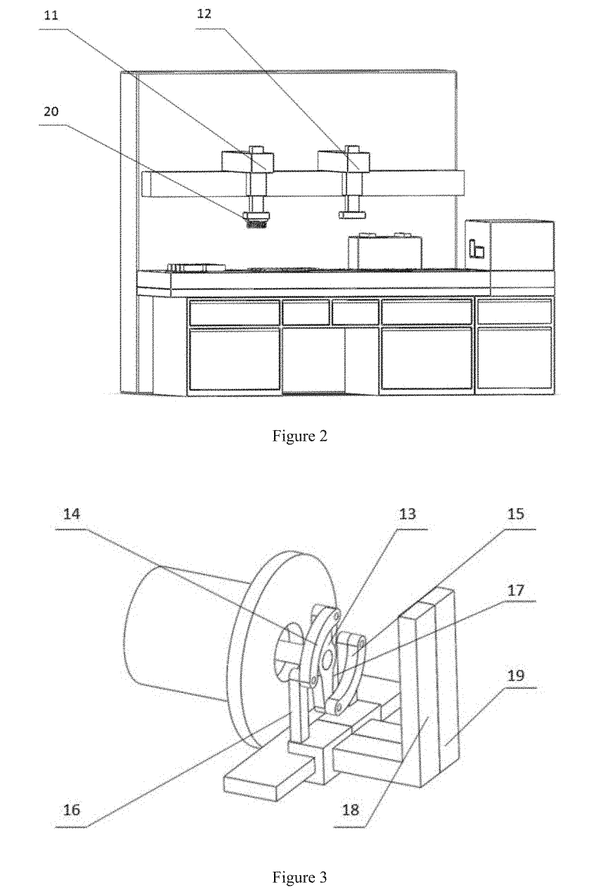

As shown in FIG. 2, the clamping device at the end of the manipulator can be used to hold the 96-well plates for easy handling. The first connecting rod 13 of the clamping device is driven directly by motor and the ends are connected with the second connecting rod 14 and the third 15 through the pin respectively and are rotatable along the junction; the second connecting rod 14 is connected with the fourth 16 through the pin and is rotatable along the junction; the third connecting rod 15 is connected with the fifth 17 through the pin and is rotatable along the junction; the fourth connecting rod 16 and the fifth 17 are respectively fixedly connected with the first fixture block 18 and the second one 19; When the motor drives the first connecting rod 13 to rotate, the second 14, the third 15, the fourth 16 and the fifth 17 rotated along with the first rod 13; The first fixture block 18 and the second 19 relatively moved in the horizontal direction; When the motor turns forward or reverses, the first fixture block 18 and second 19 lose or clamp the 96-well plate or the pipetting head container.

The 96-channal pipette on the first slipway 11 takes pipetting heads from 96-head container and then moves to the 96-deep well plate to draw the liquid and discharge it to the 96-shallow well plate; thus the pipetting operation is completed. The 96-channal pipette moves to the top of the 96-head container and discharges waste heads into the pipetting head container after liquid discharging. The manipulator carries the 96-deep well plate and pipetting heads container to the corresponding recycling platform.

The 96-channal pipette of coloring device adds staining agent to the supernatant in 96-shallow well plate and then the manipulator carries the plate to the microplate reader for mixing and detecting, finally carries the plate to recycling platform after detection.

The microplate reader with oscillating mixer can be Cytation 3 cell imaging multi-mode reader of BioTek® Instruments, Inc (with a system integrated automatic digital microscope and/or microplate detector, with a filter-based high-performance detection optical path and grating-based highly flexible detection optical path). The automated loading and unloading manipulator wherein said is equipped with a visual sensor for automatically holding the well plate on loading platform in sequence.

The high-throughput screening system based on single manipulator is equipped with sensors for detecting the reign and leave of the well plate or head container at each working position. The motor of manipulator is equipped with a coded sensor, and clamping device in the end of the manipulator is equipped with a pressure sensor.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A high-throughput screening system based on single manipulator, comprising an automated loading and unloading manipulator, a deep well plate loading platform, a shallow well plate loading platform, a pipetting head loading platform, a control cabinet, a waste pipetting heads container platform, a shallow well plate recycling platform, a deep well plate recycling platform, a microplate reader with an oscillating mixer and an items-placing platform in a counterclockwise or clockwise order.

2. The high-throughput screening system based on single manipulator according to claim 1, comprising an automated loading and unloading manipulator, a 96-deep well plate loading platform, a 96-shallow well plate loading platform, a 96-pipetting head loading platform, a control cabinet, a 96-waste pipetting heads container platform, a 96-shallow well plate recycling platform, a 96-deep well plate recycling platform, a microplate reader with an oscillating mixer and an items-placing platform.

3. The high-throughput screening system based on single manipulator according to claim 2, wherein the automated loading and unloading manipulator is configured to carry a 96-shallow well plate, a 96-deep well plate and pipetting heads container to an appropriate position on the items-placing platform; wherein after adding staining agent, the automated loading and unloading manipulator is configured to carry the 96-shallow well plate to the microplate reader for detection; wherein after detection, the automated loading and unloading manipulator is configured to carry the 96-shallow well plate and used pipetting head container to a corresponding recycling platform.

4. The high-throughput screening system based on single manipulator according to claim 1, wherein the automated loading and unloading manipulator is configured to rotate 360 degrees to ensure rationalization of a loading and unloading schedule.

5. The high-throughput screening system based on single manipulator according to claim 2, wherein said items-placing platform comprises two 3-DOF slipways for drawing supernatant from the 96-deep well plate and adding staining agent separately; wherein each of the two 3-DOF slipways comprises an installed 96-channal pipetting system.

6. The high-throughput screening system based on single manipulator according to claim 1, wherein an end of the automated loading and unloading manipulator is provided with a clamping device to hold 96-well plates or head containers for easy handling; wherein a first connecting rod of the clamping device is configured to be driven directly by a motor, and both ends of the first connecting rod are configured to be connected with a second connecting rod and a fourth connecting rod respectively through a pin respectively and are rotatable along its junction; wherein the second connecting rod is configured to be connected with a third connecting rod through a pin and is rotatable along its junction; wherein the fourth connecting rod is configured to be connected with a fifth connecting rod through a pin and is rotatable along its junction; wherein the third connecting rod and the fifth connecting rod are respectively fixedly connected with a first fixture block and a second fixture block.

7. The high-throughput screening system according to claim 1, wherein a working station of the screening system is equipped with a sensor.

8. The high-throughput screening system according to claim 5, wherein said slipway is equipped with a collision sensor; and an end of the automated loading and unloading manipulator is equipped with a clamping device which is equipped a pressure sensor.

9. The high-throughput screening system according to claim 2, wherein said 96-deep well plate and the 96-shallow well plate are interchangeable with other multi-well plates.
